(19) United States
(12) Patent Application Publication
(10) Pub. No.: US 2025/0150396 A1
(43) Pub. Date: May 8, 2025

(54) LOAD BALANCING FOR WEIGHTED EQUAL COST MULTI-PATH (ECMP)

(71) Applicant: Marvell Asia Pte Ltd, Singapore (SG)

(72) Inventors: Rupa BUDHIA, San Jose, CA (US); Puneet AGARWAL, Santa Clara, CA (US)

(21) Appl. No.: 18/939,380

(22) Filed: Nov. 6, 2024

Related U.S. Application Data
(60) Provisional application No. 63/547,668, filed on Nov. 7, 2023.

(51) Int. Cl. H04L 47/125; H04L 45/24

(52) U.S. Cl. CPC H04L 47/125; H04L 45/24

(57) ABSTRACT

Techniques as described herein may be implemented to support selecting a transmission path in a multi-path network link. In an embodiment, respective cumulative data carrying capacities for selected network paths in a group of network paths defining a multi-path group used to forward network packets from a first network node to a second network node are computed. A cumulative capacity comparison value for a received network packet in a flow of network packets is computed based at least in part on a hash value used to distinguish the flow from other flows of network packets. A specific network path is selected from amongst the network paths of the multi-path group, over which to forward the received network packet from the first network node towards the second network node, based on comparing the cumulative capacity comparison value with at least a subset of the cumulative data carrying capacities.

### CROSS-REFERENCE TO RELATED APPLICATIONS

This application claims the benefit of priority to U.S. Provisional Patent Application No. 63/547,668 filed on Nov. 7, 2023, which is hereby incorporated by reference.

### TECHNICAL FIELD

Embodiments relate generally to computer network communications, and, more specifically, to load balancing for weighted equal cost multi-path (ECMP).

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A multi-path group such as a weighted cost multi-path (WCMP) or equal cost multi-path (ECMP) group may be used to forward network packets from a first network node to a second network node in a communication network. The multi-path group may include a plurality of network paths, each of which may be used to forward network packets from the first network node to the second network node. A WCMP group is a group of next-hop addresses for a destination in a network switch's multipath table, where each address has a different cost. WCMP stands for Weighted Cost Multipathing, which is a method for allocating bandwidth fairly across flows. WCMP groups are used to distribute traffic flows proportionally to the assigned weights. An ECMP group is a list of unique next hops that are referenced by multiple ECMP routes. ECMP stands for Equal Cost Multipath, which is a routing technique that distributes incoming data traffic evenly over multiple equal-cost connections.

On occasion, network links among the network links that constitute the plurality of network paths in the multi-path group may be operationally down or out of service thus causing some network paths in the multi-path group to be unavailable for packet forwarding. Algorithms that otherwise work well to distribute traffic loads of network packets amongst the plurality of network paths may no longer distribute the traffic loads evenly or proportionally among working network paths among the plurality of network paths when network link failures occur.

Algorithms adapted to deal with network link failures affecting multi-path groups may incur significantly more complexity and memory usage. A network may have a multitude, sometimes thousands or even more, of concurrent multi-path groups in operation at any given time. As a result, in devices that employ conventional approaches for multi-path selection, the additional complexity and memory usage to support numerous concurrent multi-path groups may cause networking devices to incur relatively large size and high complexity and power consumption in hardware and/or software.

### BRIEF DESCRIPTION OF DRAWINGS

The present inventive subject matter is illustrated by way of example, and not by way of limitation, in the figures of the accompanying drawings and in which like reference numerals refer to similar elements and in which:

FIG. 1A illustrates an example network device such as a switch or router; FIG. 1B illustrates an example networking system; FIG. 1C and FIG. 1D illustrate an example multi-path groups;

FIG. 2A and FIG. 2B illustrate example path selectors that may be implemented by network devices;

FIG. 3A through FIG. 3I illustrate example path members and corresponding path-specific data values in a multi-path group;

FIG. 4A and FIG. 4B illustrate example process flows;

FIG. 5 is block diagram of an example computer system upon which embodiments of the inventive subject matter may be implemented.

### DETAILED DESCRIPTION OF THE INVENTION

In the following description, for the purposes of explanation, numerous specific details are set forth in order to provide a thorough understanding of the present inventive subject matter. It will be apparent, however, that the present inventive subject matter may be practiced without these specific details. In other instances, well-known structures and devices are shown in block diagram form in order to avoid unnecessarily obscuring the present inventive subject matter.

### 1.0 GENERAL OVERVIEW

Multi-path groups are frequently used in large communication networks to enable robust and high performance communications between different network nodes in the networks. For example, a multi-path group offers multiple network paths to a network device such as a network switch or router to forward network data packets from a given network node such as a source network node to a destination network node.

When the paths in the multi-path group are equal cost or have equal data carrying capacities, the network device may evenly distribute traffic flows across all the paths. When the paths in the multi-path group are not equal cost or do not have equal data carrying capacities, the network device may replicate the paths into multiple instances as a reflection of the data carrying capacity of the different paths, wherein each replicated path represents a common denominator or unit capacity among the different data carrying capacities. By using replicated paths, the network device may distribute the traffic flows across all the paths proportional to their respective data carrying capacities.

In operation, link failures or maintenance operations may affect a subset of the paths in the multi-path group and thereby cause changes of data carrying capacities in the subset of the paths. As a result, replications of the paths for the purpose of distributing traffic flows need to be performed repetitively in response to these changes. This may lead to a relatively high power consumption and memory usage for the network device, thereby placing significant constraints on the network device as to how many multi-path groups could be implemented/supported and how many path replications could be performed/supported in actual network switching/routing operation.

Techniques as described herein can be used to implement a (e.g., hardware-based, etc.) weighted load balancing (or traffic distribution) algorithm/method that need not perform any replication of paths or path members in a multi-path group. The algorithm/method or corresponding process flow may—but is not necessarily limited to—be implemented (e.g., entirely, over 90% operations, etc.) in hardware with minimized area or footprint. As a result, a network device implementing some or all techniques as described herein can be scaled to concurrently support a relatively large number of multi-path groups and a relatively large number of (non-replicated) paths in the multi-path groups concurrently with relatively low time latency, memory usage, and power consumption.

In some operational scenarios, cumulative data carrying capacities may be computed based on weights—e.g., proportional or corresponding to individual path-specific data carrying capacities-assigned to path members of a multi-path group. The path members may be indexed or ordered using respective index values. For a given path members among the path members, a cumulative data carrying capacity may be computed by aggregating all weights of previous path members of the path members and of the path member itself.

The cumulative capacities may continue to be used without re-computation for load balancing or traffic distribution purposes, until any change occurs in the individual path-specific data carrying capacities or until any path member is added to or removed from the multi-path group. When such changes in data carrying capacities and path member compositions occur, the total number of cumulative data carrying capacities does not change or change minimally. For example, when only one path is added or removed with respect to the multi-path group, the total number of cumulative data carrying capacities only changes by a difference of one (1). The total number of path members or their respective cumulative data carrying capacities may change by more than one (1) if multiple path members are added or deleted at the same time. When a data carrying capacity of an existing path in the multi-path group is changed, the total number of path members or their respective data carrying capacities does not change.

Under techniques as described herein, the cumulative data carrying capacities may be used as thresholds to compare with a cumulative capacity (or threshold) comparison value derived in part from a flow-specific value (or a capacity comparison value) used to distinguish a traffic flow of network data packets from other traffic flows. The flow-specific value may be computed from properties or data fields shared by network packets in a flow of network packets. The flow-specific value may be computed with any function including but not limited to hash function. For example, a given traffic flow may include all network data packets sharing a common set of packet data field values for a set of packet data fields. This common set of packet data field values may be used to compute the flow-specific value. Other traffic flows having different sets of packet data field values for the set of packet data fields have different flow-specific values. The cumulative capacity comparison value may not indicate the total amount of data of a received packet, but rather is used as a comparison value. A function used to derive the cumulative capacity comparison value is selected to generate output values that are evenly distributed through its valid value range. As a result, this even distribution of output values in the cumulative capacity comparison values makes distribution of packet/traffic flows evenly over all the path in accordance with their individual data carrying capacities.

In response to receiving a network packet from the first network node to be forwarded with the multi-path group to the second network node, the network device or another network node computes the above mentioned cumulative capacity (or threshold) comparison value for the network packet. This (WCMP) computation may be done at a source network node connected to multiple switches or routers or at a switch/router in the network to which the source network node is connected. This algorithm or method computes or determines the next network node to send or forward the received network data packet.

The network device can compare the comparison value with the cumulative capacities (or thresholds) of some or all path members in the multi-path group.

The network device can further use the results (e.g., binary values, etc.) of comparison operations to select a specific network path from among some or all of the path members in the multi-path group to forward the received network packet toward the second network node.

In some operational scenarios, some or all of the load balancing (or traffic distribution) algorithm, method or process flow may be implemented in hardware. Additionally, optionally or alternatively, some or all operations in the algorithm, method or process flow such as cumulative capacity (or threshold) comparison operations may be executed in parallel.

Approaches, techniques, and mechanisms are disclosed for selecting a transmission path in a multi-path network link. In an embodiment, respective cumulative data carrying capacities for selected network paths in a group of network paths defining a multi-path group used to forward network packets from a first network node to a second network node are computed. A cumulative capacity comparison value for a received network packet in a flow of network packets is computed based at least in part on a hash value used to distinguish the flow from other flows of network packets. A specific network path is selected from amongst the network paths of the multi-path group, over which to forward the received network packet from the first network node towards the second network node, based on comparing the cumulative capacity comparison value with at least a subset of the cumulative data carrying capacities.

In other aspects, the inventive subject matter encompasses computer apparatuses and/or computer-readable media configured to carry out the foregoing techniques.

### 2.0. STRUCTURAL OVERVIEW

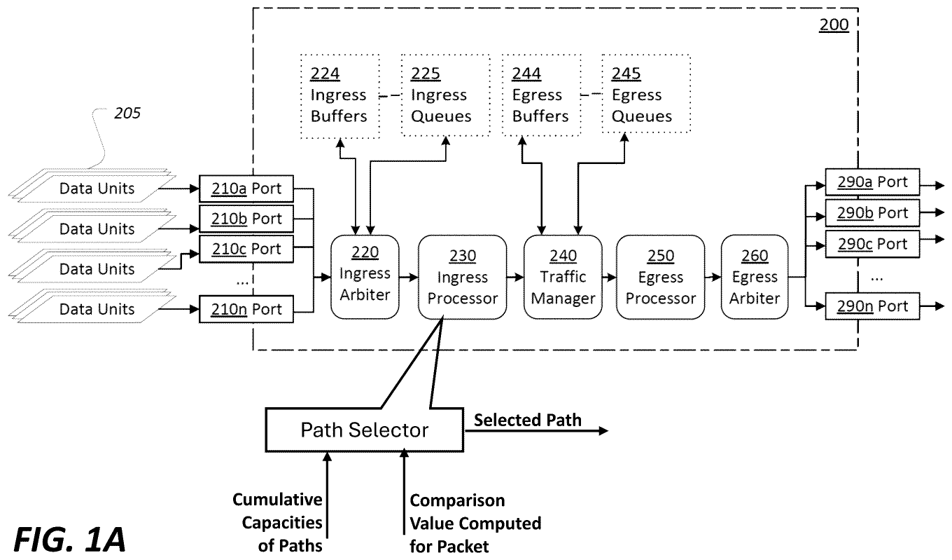

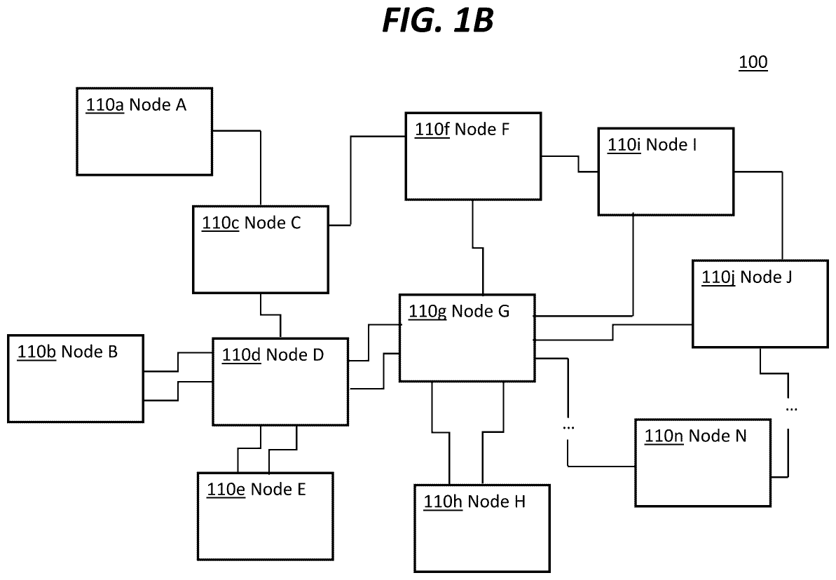

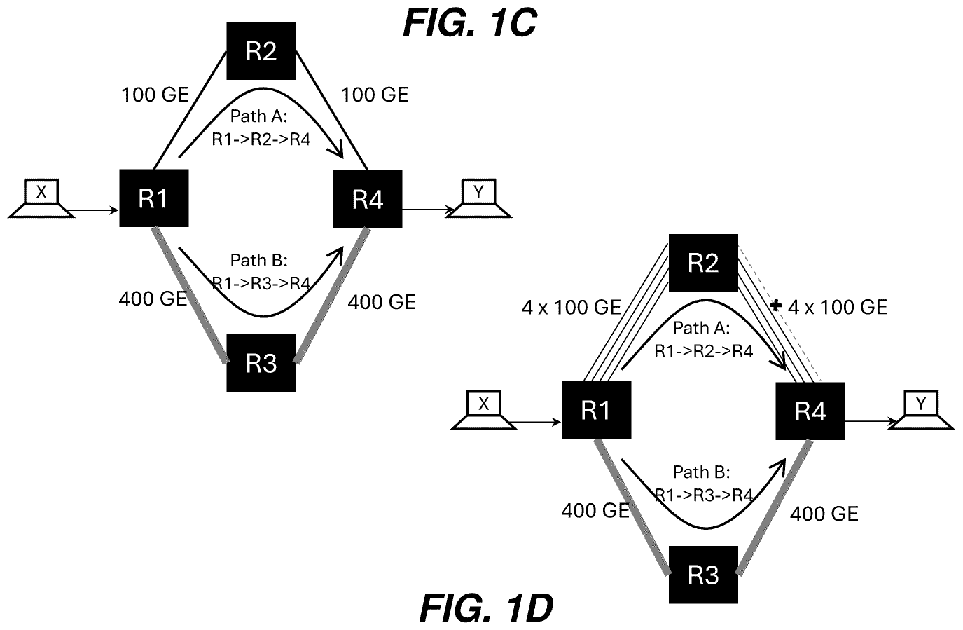

FIG. 1B illustrates example aspects of an example networking system 100, also referred to as a network, in which the techniques described herein may be practiced, according to an embodiment. Networking system 100 comprises a plurality of interconnected nodes 110a-110n (collectively nodes 110), each implemented by a different computing device. For example, a node 110 may be a single networking computing device (or a network device), such as a router or switch, in which some or all of the processing components described herein are implemented in application-specific integrated circuits (ASICs), field programmable gate arrays (FPGAs), or other integrated circuit(s). As another example, a node 110 may include one or more memories storing instructions for implementing various components described herein, one or more hardware processors configured to execute the instructions stored in the one or more memories, and various data repositories in the one or more memories for storing data structures utilized and manipulated by the various components.

Each node 110 is connected to one or more other nodes 110 in network 100 by one or more communication links, depicted as lines between nodes 110. The communication links may be any suitable wired cabling or wireless links. Note that system 100 illustrates only one of many possible arrangements of nodes within a network. Other networks may include fewer or additional nodes 110 having any number of links between them.

### 2.1. Packets and Other Data Units

While each node 110 may or may not have a variety of other functions, in an embodiment, each node 110 is configured to send, receive, and/or relay data to one or more other nodes 110 via these links. In general, data is communicated as series of discrete units or structures of data represented by signals transmitted over the communication links.

Different nodes 110 within a network 100 may send, receive, and/or relay data units at different communication levels, or layers. For instance, a first node 110 may send a data unit at the network layer (e.g., a TCP segment, IP packet, etc.) to a second node 110 over a path that includes an intermediate node 110. This data unit will be broken into smaller data units at various sublevels before it is transmitted from the first node 110. These smaller data units may be referred to as “subunits” or “portions” of the larger data unit.

For example, the data unit may be sent in one or more of: packets, cells, collections of signal-encoded bits, etc., to the intermediate node 110. Depending on the network type and/or the device type of the intermediate node 110, the intermediate node 110 may rebuild the entire original data unit before routing the information to the second node 110, or the intermediate node 110 may simply rebuild certain subunits of the data (e.g., frames and/or cells) and route those subunits to the second node 110 without ever composing the entire original data unit.

When a node 110 receives a data unit, it typically examines addressing information within the data unit (and/or other information within the data unit) to determine how to process the data unit. The addressing information may be, for instance, an Internet Protocol (IP) address, MPLS label, or any other suitable information. If the addressing information indicates that the receiving node 110 is not the destination for the data unit, the receiving node 110 may look up the destination node 110 within receiving node's routing information and route the data unit to another node 110 connected to the receiving node 110 based on forwarding instructions associated with the destination node 110 (or an address group to which the destination node belongs). The forwarding instructions may indicate, for instance, an outgoing port over which to send the data unit, a label to attach the data unit, a next hop, etc. In cases where multiple (e.g., equal-cost, non-equal-cost, etc.) paths to the destination node 110 are possible, the forwarding instructions may include information indicating a suitable approach for selecting one of those paths, or a path deemed to be the best path may already be defined.

Addressing information, flags, labels, and other metadata used for determining how to handle a data unit are typically embedded within a portion of the data unit known as the header. The header is typically at the beginning of the data unit, and is followed by the payload of the data unit, which is the information actually being sent in the data unit. A header is typically comprised of fields of different types, such as a destination address field, source address field, destination port field, source port field, and so forth. In some protocols, the number and the arrangement of fields may be fixed. Other protocols allow for arbitrary numbers of fields, with some or all of the fields being preceded by type information that explains to a node the meaning of the field.

A traffic flow is a sequence of data units, such as packets, with common attributes, typically being from a same source to a same destination. In an embodiment, the source of the traffic flow may mark each data unit in the sequence as a member of the flow using a label, tag, or other suitable identifier within the data unit. In another embodiment, the flow is identified by deriving an identifier from other fields in the data unit (e.g., a “five-tuple” or “5-tupple” combination of a source address, source port, destination address, destination port, and protocol). A flow is often intended to be sent in sequence, and network devices may therefore be configured to send all data units within a given flow along a same path to ensure that the flow is received in sequence.

Data units may be single-destination or multi-destination. Single-destination data units are typically unicast data units, specifying only a single destination address. Multi-destination data units are often multicast data units, specifying multiple destination addresses, or addresses shared by multiple destinations. However, a given node may in some circumstances treat unicast data units as having multiple destinations. For example, the node may be configured to mirror a data unit to another port such as a law enforcement port or debug port, copy the data unit to a central processing unit for diagnostic purposes or suspicious activity, recirculate a data unit, or take other actions that cause a unicast data unit to be sent to multiple destinations. By the same token, a given data unit may in some circumstances treat a multicast data unit as a single-destination data unit, if, for example all destinations targeted by the data unit are reachable by the same egress port.

For convenience, many of the techniques described in this disclosure are described with respect to routing data units that are IP packets in an L3 (level/layer 3) network, or routing the constituent cells and frames thereof in an L2 (level/layer 2) network, in which contexts the described techniques have particular advantages. It is noted, however, that these techniques may also be applied to realize advantages in routing other types of data units conforming to other protocols and/or at other communication layers within a network. Thus, unless otherwise stated or apparent, the techniques described herein should also be understood to apply to contexts in which the “data units” are of any other type of data structure communicated across a network, such as segments or datagrams. That is, in these contexts, other types of data structures may be used in place of packets, cells, frames, and so forth.

It is noted that the actual physical representation of a data unit may change as a result of the processes described herein. For instance, a data unit may be converted from a physical representation at a particular location in one memory to a signal-based representation, and back to a physical representation at a different location in a potentially different memory, as it is moved from one component to another within a network device or even between network devices. Such movement may technically involve deleting, converting, and/or copying some or all of the data unit any number of times. For simplification, however, the data unit is logically said to remain the same data unit as it moves through the device, even if the physical representation of the data unit changes. Similarly, the contents and/or structure of a data unit may change as it is processed, such as by adding or deleting header information, adjusting cell boundaries, or even modifying payload data. A modified data unit is nonetheless still said to be the same data unit, even after altering its contents and/or structure.

### 2.2. Network Paths

Any node in the depicted network 100 may communicate with any other node in the network 100 by sending data units through a series of nodes 110 and links, referred to as a path. For example, Node B (110b) may send data units to Node H (110h) via a path from Node B to Node D to Node E to Node H. There may be a large number of valid paths between two nodes. For example, another path from Node B to Node H is from Node B to Node D to Node G to Node H.

In an embodiment, a node 110 does not actually need to specify a full path for a data unit that it sends. Rather, the node 110 may simply be configured to calculate the best path for the data unit out of the device (e.g., which egress port it should send the data unit out on, etc.). When a node 110 receives a data unit that is not addressed directly to the node 110, based on header information associated with a data unit, such as path and/or destination information, the node 110 relays the data unit along to either the destination node 110, or a “next hop” node 110 that the node 110 calculates is in a better position to relay the data unit to the destination node 110. In this manner, the actual path of a data unit is product of each node 110 along the path making routing decisions about how best to move the data unit along to the destination node 110 identified by the data unit.

### 2.3. Network Device

FIG. 1A illustrates example aspects of an example network device 200 in which techniques described herein may be practiced, according to an embodiment. Network device 200 is a computing device comprising any combination of hardware and software configured to implement the various logical components described herein, including components 210-290. For example, the apparatus may be a single networking computing device, such as a router or switch, in which some or all of the components 210-290 described herein are implemented using application-specific integrated circuits (ASICs). As another example, an implementing apparatus may include one or more memories storing instructions for implementing various components described herein, one or more hardware processors configured to execute the instructions stored in the one or more memories, and various data repositories in the one or more memories for storing data structures utilized and manipulated by various components 210-290.

Device 200 is generally configured to receive and forward data units 205 to other devices in a network, such as network 100, by means of a series of operations performed at various components within the device 200. Note that, in an embodiment, some or all of the nodes 110 in system 100 may each be or include a separate network device 200. In an embodiment, a node 110 may include more than one device 200. In an embodiment, device 200 may itself be one of a number of components within a node 110. For instance, network device 200 may be an integrated circuit, or “chip,” dedicated to performing switching and/or routing functions within a network switch or router. The network switch or router further comprises one or more central processor units, storage units, memories, physical interfaces, LED displays, or other components external to the chip, some or all of which may communicate with the chip, in an embodiment.

A non-limiting example flow of a data unit 205 through various subcomponents of the forwarding logic of device 200 is as follows. After being received via a port 210, a data unit 205 may be buffered in an ingress buffer 224 and queued in an ingress queue 225 by an ingress arbiter 220 until the data unit 205 can be processed by an ingress packet processor 230, and then delivered to an interconnect (or a cross connect) such as a switching fabric. From the interconnect, the data unit 205 may be forwarded to a traffic manager 240. The traffic manager 240 may store the data unit 205 in an egress buffer 244 and assign the data unit 205 to an egress queue 245. The traffic manager 240 manages the flow of the data unit 205 through the egress queue 245 until the data unit 205 is released to an egress packet processor 250. Depending on the processing, the traffic manager 240 may then assign the data unit 205 to another queue so that it may be processed by yet another egress processor 250, or the egress packet processor 250 may send the data unit 205 to an egress arbiter 260 which temporally stores or buffers the data unit 205 in a transmit buffer and finally forwards out the data unit via another port 290. Of course, depending on the embodiment, the forwarding logic may omit some of these subcomponents and/or include other subcomponents in varying arrangements.

Example components of a device 200 are now described in further detail.

### 2.4. Ports

Network device 200 includes ports 210/290. Ports 210, including ports 210-1 through 210-N, are inbound (“ingress”) ports by which data units referred to herein as data units 205 are received over a network, such as network 110. Ports 290, including ports 290-1 through 290-N, are outbound (“egress”) ports by which at least some of the data units 205 are sent out to other destinations within the network, after having been processed by the network device 200.

Egress ports 290 may operate with corresponding transmit buffers to store data units or subunits (e.g., packets, cells, frames, transmission units, etc.) divided therefrom that are to be transmitted through ports 290. Transmit buffers may have one-to-one correspondence relationships with ports 290, many-to-one correspondence with ports 290, and so on. Egress processors 250 or egress arbiters 260 operating with egress processors 250 may output these data units or subunits to transmit buffers before these units/subunits are transmitted out from ports 290.

Data units 205 may be of any suitable PDU type, such as packets, cells, frames, transmission units, etc. In an embodiment, data units 205 are packets. However, the individual atomic data units upon which the depicted components may operate may actually be subunits of the data units 205. For example, data units 205 may be received, acted upon, and transmitted at a cell or frame level. These cells or frames may be logically linked together as the data units 205 (e.g., packets, etc.) to which they respectively belong for purposes of determining how to handle the cells or frames. However, the subunits may not actually be assembled into data units 205 within device 200, particularly if the subunits are being forwarded to another destination through device 200.

Ports 210/290 are depicted as separate ports for illustrative purposes, but may actually correspond to the same physical hardware ports (e.g., network jacks or interfaces, etc.) on the network device 210. That is, a network device 200 may both receive data units 205 and send data units 205 over a single physical port, and the single physical port may thus function as both an ingress port 210 (e.g., one of 210a, 210b, 210c, . . . 210n, etc.) and egress port 290. Nonetheless, for various functional purposes, certain logic of the network device 200 may view a single physical port as a separate ingress port 210 and a separate egress port 290. Moreover, for various functional purposes, certain logic of the network device 200 may subdivide a single physical ingress port or egress port into multiple ingress ports 210 or egress ports 290, or aggregate multiple physical ingress ports or egress ports into a single ingress port 210 or egress port 290. Hence, in some operational scenarios, ports 210 and 290 should be understood as distinct logical constructs that are mapped to physical ports rather than simply as distinct physical constructs.

In some embodiments, the ports 210/290 of a device 200 may be coupled to one or more transceivers, such as Serializer/Deserializer (“SerDes”) blocks. For instance, ports 210 may provide parallel inputs of received data units into a SerDes block, which then outputs the data units serially into an ingress packet processor 230. On the other end, an egress packet processor 250 may input data units serially into another SerDes block, which outputs the data units in parallel to ports 290.

### 2.5. Packet Processors

A device 200 comprises one or more packet processing components that collectively implement forwarding logic by which the device 200 is configured to determine how to handle each data unit 205 that is received at device 200. These packet processors components may be any suitable combination of fixed circuitry and/or software-based logic, such as specific logic components implemented by one or more Field Programmable Gate Arrays (FPGAs) or Application-Specific Integrated Circuits (ASICs), or a general-purpose processor executing software instructions.

Different packet processors 230 and 250 may be configured to perform different packet processing tasks. These tasks may include, for example, identifying paths along which to forward data units 205, forwarding data units 205 to egress ports 290, implementing flow control and/or other policies, manipulating packets, performing statistical or debugging operations, and so forth. A device 200 may comprise any number of packet processors 230 and 250 configured to perform any number of processing tasks.

In an embodiment, the packet processors 230 and 250 within a device 200 may be arranged such that the output of one packet processor 230 or 250 may, eventually, be inputted into another packet processor 230 or 250, in such a manner as to pass data units 205 from certain packet processor(s) 230 and/or 250 to other packet processor(s) 230 and/or 250 in a sequence of stages, until finally disposing of the data units 205 (e.g., by sending the data units 205 out an egress port 290, “dropping” the data units 205, etc.). The exact set and/or sequence of packet processors 230 and/or 250 that process a given data unit 205 may vary, in some embodiments, depending on the attributes of the data unit 205 and/or the state of the device 200. There is no limit to the number of packet processors 230 and/or 250 that may be chained together in such a manner.

Based on decisions made while processing a data unit 205, a packet processor 230 or 250 may, in some embodiments, and/or for certain processing tasks, manipulate a data unit 205 directly. For instance, the packet processor 230 or 250 may add, delete, or modify information in a data unit header or payload. In other embodiments, and/or for other processing tasks, a packet processor 230 or 250 may generate control information that accompanies the data unit 205, or is merged with the data unit 205, as the data unit 205 continues through the device 200. This control information may then be utilized by other components of the device 200 to implement decisions made by the packet processor 230 or 250.

In an embodiment, a packet processor 230 or 250 need not necessarily process an entire data unit 205, but may rather only receive and process a subunit of a data unit 205 comprising header information for the data unit. For instance, if the data unit 205 is a packet comprising multiple cells, the first cell, or a first subset of cells, might be forwarded to a packet processor 230 or 250, while the remaining cells of the packet (and potentially the first cell(s) as well) are forwarded in parallel to a merger component where they await results of the processing.

### Ingress and Egress Processors

In an embodiment, a packet processor may be generally classified as an ingress packet processor 230 or an egress packet processor 250. Generally, an ingress processor 230 resolves destinations for a traffic manager 240 to determine which egress ports 290 (e.g., one of 290a, 290b, 290c, . . . 290n, etc.) and/or queues a data unit 205 should depart from. There may be any number of ingress processors 230, including just a single ingress processor 230.

In an embodiment, an ingress processor 230 performs certain intake tasks on data units 205 as they arrive. These intake tasks may include, for instance, and without limitation, parsing data units 205, performing routing related lookup operations, categorically blocking data units 205 with certain attributes and/or when the device 200 is in a certain state, duplicating certain types of data units 205, making initial categorizations of data units 205, and so forth. Once the appropriate intake task(s) have been performed, the data units 205 are forwarded to an appropriate traffic manager 240, to which the ingress processor 230 may be coupled directly or via various other components, such as an interconnect component.

The egress packet processor(s) 250 of a device 200, by contrast, may be configured to perform non-intake tasks necessary to implement the forwarding logic of the device 200. These tasks may include, for example, tasks such as identifying paths along which to forward the data units 205, implementing flow control and/or other policies, manipulating data units, performing statistical or debugging operations, and so forth. In an embodiment, there may be different egress packet processors(s) 250 assigned to different flows or other categories of traffic, such that not all data units 205 will be processed by the same egress packet processor 250.

In an embodiment, each egress processor 250 is coupled to a different group of egress ports 290 to which they may send data units 205 processed by the egress processor 250. In an embodiment, access to a group of ports 290 or corresponding transmit buffers for the ports 290 may be regulated via an egress arbiter 260 coupled to the egress packet processor 250. In some embodiments, an egress processor 250 may also or instead be coupled to other potential destinations, such as an internal central processing unit, a storage subsystem, or a traffic manager 240.

### 2.6. Buffers

Since not all data units 205 received by the device 200 can be processed by component(s) such as the packet processor(s) 230 and/or 250 and/or ports 290 at the same time, various components of device 200 may temporarily store data units 205 in memory structures referred to as (e.g., ingress, egress, etc.) buffers while the data units 205 are waiting to be processed. For example, a certain packet processor 230 or 250 or port 290 may only be capable of processing a certain amount of data such as a certain number of data units 205, or portions of data units 205, in a given clock cycle, meaning that other data units 205, or portions of data units 205, destined for the packet processor 230 or 250 or port 290 must either be ignored (e.g., dropped, etc.) or stored. At any given time, a large number of data units 205 may be stored in the buffers of the device 200, depending on network traffic conditions.

A device 200 may include a variety of buffers, each utilized for varying purposes and/or components. Generally, a data unit 205 awaiting processing by a component is held in a buffer associated with that component until the data unit 205 is “released” to the component for processing.

Buffers may be implemented using any number of distinct banks of memory. Each bank may be a portion of any type of memory, including volatile memory and/or non-volatile memory. In an embodiment, each bank comprises many addressable “entries” (e.g., rows, columns, etc.) in which data units 205, subunits, linking data, or other types of data, may be stored. The size of each entry in a given bank is known as the “width” of the bank, while the number of entries in the bank is known as the “depth” of the bank. The number of banks may vary depending on the embodiment.

Each bank may have associated access limitations. For instance, a bank may be implemented using single-ported memories that may only be accessed once in a given time slot (e.g., clock cycle, etc.). Hence, the device 200 may be configured to ensure that no more than one entry need be read from or written to the bank in a given time slot. A bank may instead be implemented in a multi-ported memory to support two or more accesses in a given time slot. However, single-ported memories may be desirable in many cases for higher operating frequencies and/or reducing costs.

In an embodiment, in addition to buffer banks, a device may be configured to aggregate certain banks together into logical banks that support additional reads or writes in a time slot and/or higher write bandwidth. In an embodiment, each bank, whether logical or physical or of another (e.g., addressable, hierarchical, multi-level, sub bank, etc.) organization structure, is capable of being accessed concurrently with each other bank in a same clock cycle, though full realization of this capability is not necessary.

Some or all of the components in device 200 that utilize one or more buffers may include a buffer manager configured to manage use of those buffer(s). Among other processing tasks, the buffer manager may, for example, maintain a mapping of data units 205 to buffer entries in which data for those data units 205 is stored, determine when a data unit 205 must be dropped because it cannot be stored in a buffer, perform garbage collection on buffer entries for data units 205 (or portions thereof) that are no longer needed, and so forth.

A buffer manager may include buffer assignment logic. The buffer assignment logic is configured to identify which buffer entry or entries should be utilized to store a given data unit 205, or portion thereof. In some embodiments, each data unit 205 is stored in a single entry. In yet other embodiments, a data unit 205 is received as, or divided into, constituent data unit portions for storage purposes. The buffers may store these constituent portions separately (e.g., not at the same address location or even within the same bank, etc.). The one or more buffer entries in which a data unit 205 are stored are marked as utilized (e.g., in a “free” list, free or available if not marked as utilized, etc.) to prevent newly received data units 205 from overwriting data units 205 that are already buffered. After a data unit 205 is released from the buffer, the one or more entries in which the data unit 205 is buffered may then be marked as available for storing new data units 205.

In some embodiments, the buffer assignment logic is relatively simple, in that data units 205 or data unit portions are assigned to banks and/or specific entries within those banks randomly or using a round-robin approach. In some embodiments, data units 205 are assigned to buffers at least partially based on characteristics of those data units 205, such as corresponding traffic flows, destination addresses, source addresses, ingress ports, and/or other metadata. For example, different banks may be utilized to store data units 205 received from different ports 210 or sets of ports 210. In an embodiment, the buffer assignment logic also or instead utilizes buffer state information, such as utilization metrics, to determine which bank and/or buffer entry to assign to a data unit 205, or portion thereof. Other assignment considerations may include buffer assignment rules (e.g., no writing two consecutive cells from the same packet to the same bank, etc.) and I/O scheduling conflicts, for example, to avoid assigning a data unit to a bank when there are no available write operations to that bank on account of other components reading content already in the bank.

### 2.7. Queues

In an embodiment, to manage the order in which data units 205 are processed from the buffers, various components of a device 200 may implement queueing logic. For example, the flow of data units through ingress buffers 224 may be managed using ingress queues 225 while the flow of data units through egress buffers 244 may be managed using egress queues 245.

Each data unit 205, or the buffer locations(s) in which the data unit 205 is stored, is said to belong to one or more constructs referred to as queues. Typically, a queue is a set of memory locations (e.g., in the buffers 224 and/or 244, etc.) arranged in some order by metadata describing the queue. The memory locations may (and often are) non-contiguous relative to their addressing scheme and/or physical or logical arrangement. For example, the metadata for one queue may indicate that the queue is comprised of, in order, entry addresses 2, 50, 3, and 82 in a certain buffer.

In many embodiments, the sequence in which the queue arranges its constituent data units 205 generally corresponds to the order in which the data units 205 or data unit portions in the queue will be released and processed. Such queues are known as first-in-first-out (“FIFO”) queues, though in other embodiments other types of queues may be utilized. In some embodiments, the number of data units 205 or data unit portions assigned to a given queue at a given time may be limited, either globally or on a per-queue basis, and this limit may change over time.

### 2.8. Traffic Manager

According to an embodiment, a device 200 further includes one or more traffic managers 240 configured to control the flow of data units to one or more packet processor(s) 230 and/or 250. For instance, a buffer manager within the traffic manager 240 may temporarily store data units 205 in buffers 244 as they await processing by egress processor(s) 250. A traffic manager 240 may receive data units 205 directly from a port 210, from an ingress processor 230, and/or other suitable components of device 200. In an embodiment, the traffic manager 240 receives one TDU from each possible source (e.g. each port 210, etc.) each clock cycle or other time slot.

Traffic manager 240 may include or be coupled to egress buffers 244 for buffering data units 205 prior to sending those data units 205 to their respective egress processor(s) 250. A buffer manager within the traffic manager 240 may temporarily store data units 205 in egress buffers 244 as they await processing by egress processor(s) 250. The number of egress buffers 244 may vary depending on the embodiment. A data unit 205 or data unit portion in an egress buffer 244 may eventually be “released” to one or more egress processor(s) 250 for processing, by reading the data unit 205 from the (e.g., egress, etc.) buffer 244 and sending the data unit 205 to the egress processor(s) 250. In an embodiment, traffic manager 240 may release up to a certain number of data units 205 from buffers 244 to egress processors 250 each clock cycle or other defined time slot.

Beyond managing the use of buffers 244 to store data units 205 (or copies thereof), a traffic manager 240 may include queue management logic configured to assign buffer entries to queues and manage the flow of data units 205 through the queues. The traffic manager 240 may, for instance, identify a specific queue to assign a data unit 205 to upon receipt of the data unit 205. The traffic manager 240 may further determine when to release—also referred to as “dequeuing”—data units 205 (or portions thereof) from queues and provide those data units 205 to specific packet processor(s) 250. Buffer management logic in the traffic manager 240 may further “deallocate” entries in a buffer 244 that store data units 205 are no longer linked to the traffic manager's queues. These entries are then reclaimed for use in storing new data through a garbage collection process.

In an embodiment, different queues may exist for different destinations. For example, each port 210 and/or port 290 may have its own set of queues. The queue to which an incoming data unit 205 is assigned and linked may, for instance, be selected based on forwarding information indicating which port 290 the data unit 205 should depart from. In an embodiment, a different egress processor 250 may be associated with each different set of one or more queues. In an embodiment, the current processing context of the data unit 205 may be used to select which queue a data unit 205 should be assigned to.

In an embodiment, there may also or instead be different queues for different flows or sets of flows. That is, each identifiable traffic flow or group of traffic flows is assigned its own set of queues to which its data units 205 are respectively assigned.

Device 200 may comprise any number (e.g., one or more, etc.) of packet processors 230 and/or 250 and traffic managers 240. For instance, different sets of ports 210 and/or ports 290 may have their own traffic manager 240 and packet processors 230 and/or 250. As another example, in an embodiment, the traffic manager 240 may be duplicated for some or all of the stages of processing a data unit. For example, system 200 may include a traffic manager 240 and egress packet processor 250 for an egress stage performed upon the data unit 205 exiting the system 200, and/or a traffic manager 240 and packet processor 230 or 250 for any number of intermediate stages. The data unit 205 may thus pass through any number of traffic managers 240 and/or packet processors 230 and/or 250 prior to exiting the system 200.

In an embodiment, a traffic manager 240 is coupled to the ingress packet processor(s) 230, such that data units 205 (or portions thereof) are assigned to buffers only upon being initially processed by an ingress packet processor 230. Once in an egress buffer 244, a data unit 205 (or portion thereof) may be “released” to one or more egress packet processor(s) 250 for processing, either by the traffic manager 240 sending a link or other suitable addressing information for the corresponding buffer 244 to the egress packet processor 250, or by sending the data unit 205 directly.

In the course of processing a data unit 205, a device 200 may replicate a data unit 205 one or more times for purposes such as, without limitation, multicasting, mirroring, debugging, and so forth. For example, a single data unit 205 may be replicated to multiple egress queues 245. Any given copy of the data unit may be treated as a received packet to be routed or forwarded with a multi-path group under techniques as described herein. For instance, a data unit 205 may be linked to separate queues for each of ports 1, 3, and 5. As another example, a data unit 205 may be replicated a number of times after it reaches the head of a queue (e.g., for different egress processors 250, etc.). Hence, though certain techniques described herein may refer to the original data unit 205 that was received by the device 200, it is noted that those techniques will equally apply to copies of the data unit 205 that have been generated for various purposes. A copy of a data unit 205 may be partial or complete. Moreover, there may be an actual copy of the data unit 205 in buffers, or a single copy of the data unit 205 may be linked from a single buffer location to multiple queues at the same time.

### 2.9. Forwarding Logic

The logic by which a device 200 determines how to handle a data unit 205—such as where and whether to send a data unit 205, whether to perform additional processing on a data unit 205, etc.—is referred to as the forwarding logic of the device 200. This forwarding logic is collectively implemented by a variety of the components of the device 200, such as described above. For example, an ingress packet processor 230 may be responsible for resolving the destination of a data unit 205 and determining the set of actions/edits to perform on the data unit 205, and an egress packet processor 250 may perform the edits. Or, the egress packet processor 250 may also determine actions and resolve a destination in some cases. Also, there may be embodiments when the ingress packet processor 230 performs edits as well.

The forwarding logic may be hard-coded and/or configurable, depending on the embodiment. For example, the forwarding logic of a device 200, or portions thereof, may, in some instances, be at least partially hard-coded into one or more ingress processors 230 and/or egress processors 250. As another example, the forwarding logic, or elements thereof, may also be configurable, in that the logic changes over time in response to analyses of state information collected from, or instructions received from, the various components of the device 200 and/or other nodes in the network in which the device 200 is located.

In an embodiment, a device 200 will typically store in its memories one or more forwarding tables (or equivalent structures) that map certain data unit attributes or characteristics to actions to be taken with respect to data units 205 having those attributes or characteristics, such as sending a data unit 205 to a selected path, or processing the data unit 205 using a specified internal component. For instance, such attributes or characteristics may include a Quality-of-Service level specified by the data unit 205 or associated with another characteristic of the data unit 205, a flow control group, an ingress port 210 through which the data unit 205 was received, a tag or label in a packet's header, a source address, a destination address, a packet type, or any other suitable distinguishing property. A traffic manager 240 may, for example, implement logic that reads such a table, determines one or more ports 290 to send a data unit 205 to based on the table, and sends the data unit 205 to an egress processor 250 that is coupled to the one or more ports 290.

According to an embodiment, the forwarding tables describe groups of one or more addresses, such as subnets of IPV4 or IPv6 addresses. Each address is an address of a network device on a network, though a network device may have more than one address. Each group is associated with a potentially different set of one or more actions to execute with respect to data units that resolve to (e.g., are directed to, etc.) an address within the group. Any suitable set of one or more actions may be associated with a group of addresses, including without limitation, forwarding a message to a specified “next hop,” duplicating the message, changing the destination of the message, dropping the message, performing debugging or statistical operations, applying a quality of service policy or flow control policy, and so forth.

For illustrative purposes, these tables are described as “forwarding tables,” though it will be noted that the extent of the action(s) described by the tables may be much greater than simply where to forward the message. For example, in an embodiment, a table may be a basic forwarding table that simply specifies a next hop for each group. In other embodiments, a table may describe one or more complex policies for each group. Moreover, there may be different types of tables for different purposes. For instance, one table may be a basic forwarding table that is compared to the destination address of each packet, while another table may specify policies to apply to packets upon ingress based on their destination (or source) group, and so forth.

In an embodiment, forwarding logic may read port state data for ports 210/290. Port state data may include, for instance, flow control state information describing various traffic flows and associated traffic flow control rules or policies, link status information indicating links that are up or down, port utilization information indicating how ports are being utilized (e.g., utilization percentages, utilization states, etc.). Forwarding logic may be configured to implement the associated rules or policies associated with the flow(s) to which a given packet belongs.

As data units 205 are routed through different nodes in a network, the nodes may, on occasion, discard, fail to send, or fail to receive certain data units 205, thus resulting in the data units 205 failing to reach their intended destination. The act of discarding of a data unit 205, or failing to deliver a data unit 205, is typically referred to as “dropping” the data unit. Instances of dropping a data unit 205, referred to herein as “drops” or “packet loss,” may occur for a variety of reasons, such as resource limitations, errors, or deliberate policies. Different components of a device 200 may make the decision to drop a data unit 205 for various reasons. For instance, a traffic manager 240 may determine to drop a data unit 205 because, among other reasons, buffers are overutilized, a queue is over a certain size, and/or a data unit 205 has a certain characteristic.

### 2.10. Path Selectors

At any network node in a communication (or computer) network, there may be multiple paths for the network node to forward network packets (or network/packet traffic) to reach a specific network node such as an endpoint/destination for the network packets. The set constituted by these multiple (candidate or available) paths for forwarding network packets to the specific network node such as the endpoint or destination may be referred to as a multi-path group. Example multi-path groups may include, but are not necessarily limited to only, WCMP (Weighted Cost Multi-Path) groups, link aggregation groups (LAGs) or Equal Cost Multi-Path (ECMP) groups, and so on.

One or more path selectors may be implemented in each of one or more packet processing components such as ingress packet processors 230 as illustrated in FIG. 1A, traffic managers, egress packet processors, and so on. Some or all of a path selector as described herein may be implemented in hardware, software or a combination of hardware and software. The path selector may implement or perform a load balancing (or traffic distribution) algorithm, method or process flow to distribute various (traffic) flows of network data packets over multiple paths (or path members) in a multi-path group from an incoming network node to a destination network node. In some operational scenarios, a selected path by a path selector implemented as a part of an ingress packet processor 230 may be generated by comparing a comparison value computed for a received packet with respective cumulative capacities of individual paths in a multi-path group as thresholds. The selected path may be further used by a traffic manager 240, an egress packet processor 250, etc., to send the packet along the select path to the next hop.

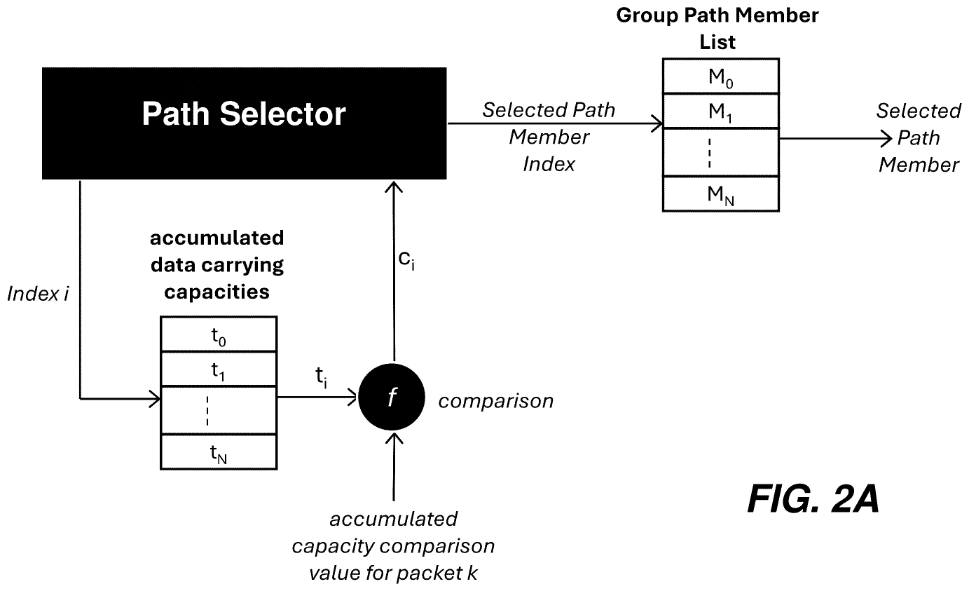

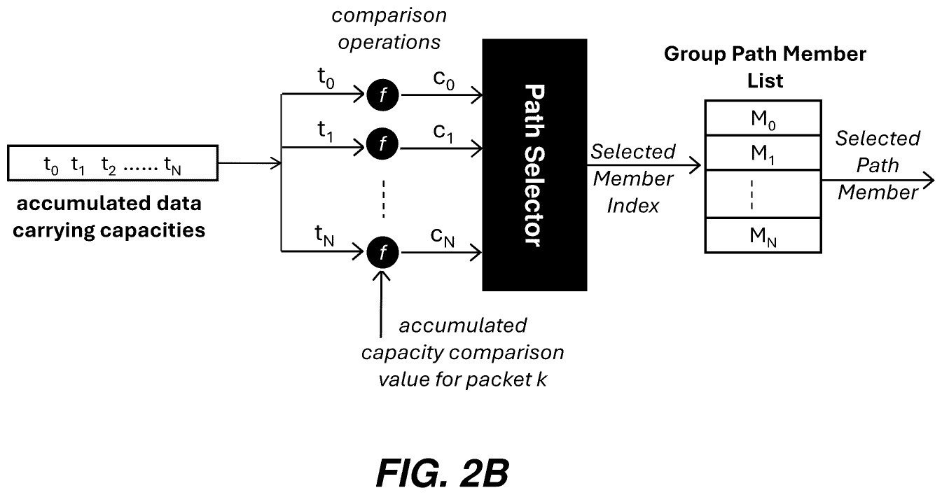

FIG. 2A illustrates an example (e.g., hardware, etc.) implementation of a path selector of FIG. 1A used to perform a load balancing algorithm/method for distributing traffic among multiple path members in a multi-path group (e.g., a WCMP group, etc.). The path selector can be implemented in hardware with relatively small (e.g., hardware, three times less, eight times less, etc.) area on a semiconductor chip or chiplet. In addition, at runtime, the path selector can perform the load balancing or traffic distribution algorithm, method or process flow under techniques as described herein with relatively low (e.g., three times less, eight times less, etc.) runtime power consumption and memory usage.

Under other approaches, even when the total number of path members in a multi-path group is relatively small such as less than sixteen, repetitions of path members for the purpose of running or performing load balancing under these other approaches may cause the total number of repeated instances of the path members in the multi-path group to a relatively large number such as 256. As a result, memory consumption as well as runtime power consumption are increased multiple folds of the total number of path members in the multi-path group under these other approaches.

In contrast, under techniques as described herein, in some operational scenarios, the implementation of the load balancing algorithm/method can include only a single array or a single one dimensional vector of (e.g., WCMP group member, etc.) thresholds or thresholds t₀, t₁ . . . t_{N}, where N is the total number of (non-repetitive, unique, distinct, different, multiple instances of the same path members with split weights aggregated to the weight assigned to the path member, etc.) path members in the multi-path group. Each of thresholds or threshold values in the single array or one-dimensional vector (or a corresponding lookup table) can be only one byte, only one two-byte short word, only one four-byte word, and so on. In some operational scenarios, a threshold or threshold value can be fewer than eight (8) bits. Hence, runtime computed data such as thresholds can be stored in memory at a relatively small data size or footprint. Accordingly, the area in hardware to store the runtime computed data in the form of a single array or a single one dimensional vector of (e.g., WCMP group member, etc.) thresholds or thresholds t₀, t₁ . . . t_{N} can be minimized or optimized under techniques as described herein.

As shown in FIG. 2A, these thresholds t₀, t₁ . . . t_{N} may be referred to as cumulative data carrying capacities. In some operational scenarios, individual data carrying capacities of path members M₀, M₁ . . . . M_{N} in the multi-path group may be assigned to or represented by respective individual weights. The path members in the multi-path group may be indexed (or ordered based on index values) into a sequence or array denoted as a Group Path Member List in FIG. 2A. A threshold tᵢ (or a respective cumulative data carrying capacity) for a respective t-th member path Mᵢ may be computed by aggregating all weights of all previous path members up to the weight of the i-th path member Mᵢ. As these weights represent individual data carrying capacities of the M₀, M₁ . . . Mᵢ, the threshold represents the respective cumulative data carrying capacity up to the i-th path member Mᵢ. As can be seen in FIG. 2A, all the thresholds or corresponding cumulative data carrying capacities t₀, t₁ . . . t_{N} may be stored as a single array or sequence.

The path selector receives, computes or determines a flow-specific value such as a hash H (or a value of a non-hash function in some other operational scenarios) of a network packet in a flow to be forwarded by the multi-path group and derives a threshold (or cumulative capacity) comparison value k from H or a derived version of H as a modulo of the last threshold t_{N} or the largest cumulative data carrying capacity in the multi-path group.

The path selector can walk through or iterate over all the members through using an index i with lookup values in a specific order (e.g., sequential, from 0 to N, up to N iteration, etc.) as a lookup key into the single array/vector/table of thresholds (or cumulative data carrying capacities) to access each of some or all of the thresholds. For each threshold looked up from the single array/vector/table of thresholds, a comparison operation (denoted as “f”) is performed between the threshold and the threshold comparison value k to generate a binary comparison value cᵢ of either zero (0) or one (1). Based on binary comparison values such as cᵢ for some or all of the path members in the multi-path group, a selected path member index is identified from (a list or plurality of) the path members M₀, M₁, . . . M_{N} in the multi-path group. The selected path member may be used by a network node with this implementation of the load balancing algorithm/method to forward the network packet.

FIG. 2B illustrates another example (e.g., hardware, etc.) implementation of a path selector of FIG. 1A used to perform a load balancing algorithm/method for distributing traffic among multiple path members in a multi-path group (e.g., a WCMP group, etc.). The path selector can be implemented in hardware with relatively small (e.g., hardware, three times less, eight times less, etc.) area on a semiconductor chip or chiplet. In addition, at runtime, the path selector can perform the load balancing or traffic distribution algorithm, method or process flow under techniques as described herein with relatively low (e.g., three times less, eight times less, etc.) runtime power consumption and memory usage.

In this implementation, some or all comparison operations (“f”) are performed between the thresholds (or cumulative data carrying capacities) t₀, t₁ . . . t_{N} of all of the (group) path member in the multi-path group and the computed threshold comparison value k for the network packet in parallel. In comparison, in FIG. 2A, some or all of the same operations may be implemented to be performed in series in operation.

Hence, this (e.g., hardware, etc.) implementation of FIG. 2B can select or complete the selection of a specific path member in the multi-path group (e.g., WCMP group, etc.) in a single iteration within a relatively few clock cycles down to a single clock cycle, regardless of the size or total number of path members of the multi-path group, at a slightly higher cost in complexity or area as compared with the implementation of FIG. 2A.

### 2.11. Miscellaneous

FIG. 1B, FIG. 1A, FIG. 2A and FIG. 2B illustrate only examples of many possible arrangements of devices configured to provide the functionality described herein. Other arrangements may include fewer, additional, or different components, and the division of work between the components may vary depending on the arrangement. Moreover, in an embodiment, the techniques described herein may be utilized in a variety of computing contexts other than within a network 100 or a network device 200.

Furthermore, figures herein illustrate but a few of the various arrangements of memories that may be utilized to implement the described buffering techniques. Other arrangements may include fewer or additional elements in varying arrangements.

### 3.0. FUNCTIONAL OVERVIEW

Described in this section are various example method flows for implementing various features of the systems and system components described herein. The example method flows are non-exhaustive. Alternative method flows and flows for implementing other features will be apparent from the disclosure.

The various elements of the process flows described below may be performed in a variety of systems, including in one or more devices 500 that utilize some or all of the load balancing or traffic distribution mechanisms described herein. In an embodiment, each of the processes described in connection with the functional blocks described below may be implemented using one or more integrated circuits, logic components, computer programs, other software elements, and/or digital logic in any of a general-purpose computer or a special-purpose computer, while performing data retrieval, transformation, and storage operations that involve interacting with and transforming the physical state of memory of the computer.

### 3.1. Weight-Based Traffic Distribution

When a node is forwarding its traffic to a destination via an ECMP composed of multiple (group) path members all of the same or equal cost, the node may simply distribute the traffic equally or evenly across all multiple path members in the ECMP.

Sometimes, path members in a multi-path group may not be of the same or equal cost. A node that is forwarding its traffic to a destination via such a multi-path group may distribute the traffic unevenly across the multiple path members of the multi-path group.

FIG. 1C illustrates an example multi-path group with two path members of unequal costs. A network node such as router R1 may use the multi-path group to forward network packets originated from a computing device X (an origination/endpoint) to a computing device Y (a destination/endpoint).

The two paths are formed or supported by network links among network nodes such as routers R1, R2, R3 and R4. Network links R1 to R2 and R2 to R4 may be 100G Ethernet links, whereas network links R1 to R3 and R3 to R4 may be 400G Ethernet links. As a result, the two path members constituting the multi-path group for the network node or router R1 include a first path member (Path A) of 100G supported by the network links R1 to R2 and R2 to R4 and a second path member (Path B) of 400G supported by the network links R1 to R3 and R3 to R4. Hence, Path B (R1-R3-R4) has four (4) times the packet forwarding capacity of Path A (R1-R2-R4).

In some operational scenarios, individual costs of path members in a multi-path group may be respectively and inversely proportions to individual data packet forwarding capacities of the path members. In comparison, individual weights of path members in a multi-path group may be respectively and proportions to individual data packet forwarding capacities of the path members.

Given the difference in packet forwarding capacities of the two path members in the multi-path group, the network node or router R1 may implement or perform multi-path load balancing algorithms that distribute network or packet traffic across the two path members unevenly or in proportion to their respective packet forwarding capacities of the two path members or in inverse proportion to their respective costs of the two path members.

For example, when the network node R1 receives the traffic from X destined for Y, the network node R1 may implement or perform a weight based multi-path load balancing algorithm with which the traffic portion of a path (or path member) in the multi-path group may be distributed in proportion to its weight, which may be assigned to be proportional to the data packet forwarding capacity of the path.

In the present example, to distribute 1/5 of the traffic over Path A and 4/5 of the traffic over Path B, different weights may be assigned to the two paths available at the network node R1 to forward the traffic to Y, as follows:

Weight of Path A=1 (1-1)

Weight of Path B=4 (1-2)

FIG. 1D illustrates another example multi-path group with two path members of initially equal costs or data packet forwarding capacities. A network node such as router R1 may use the multi-path group to (e.g., different flows of, etc.) forward network packets originated from a computing device X (an origination/endpoint) to a computing device Y (a destination/endpoint).

The two paths are formed or supported by network links among network nodes such as routers R1, R2, R3 and R4. Network links R1 to R2 and R2 to R4 may be 4×100G Ethernet links, whereas network links R1 to R3 and R3 to R4 may be 400G Ethernet links. Hence, Path A and Path B in the multi-path group of FIG. 1D have the same (packet forwarding) capacity initially. As a result, to distribute 1/2 of the traffic over Path A and 1/2 of the traffic over Path B evenly, the same weight may be assigned to the two paths available at the network node R1 to forward the traffic to Y, as follows:

Weight of Path A=1 (2-1)

Weight of Path B=1 (2-2)

However, in some operational scenarios, link failures, network maintenance or provisioning operations may affect data packet forwarding capacities of a subset of paths in a given multi-path group. For example, one link from R2 to R4 in FIG. 1D may go down or otherwise become out of service for fault or maintenance reasons. As a result, the two paths in the multi-path group are unequal in data packet forwarding capacity. Accordingly, different weights may be assigned to the two paths (or path members) available at the network node R1 to forward the traffic to Y, as follows:

Weight of Path A=3 (3-1)

Weight of Path B=4 (3-2)

A weight-based load balancing algorithm may be executed by router R1 to distribute traffic between the two paths of the multi-path group according to their current (packet forwarding) capacities: to send 3/7 of the traffic on Path A and 4/7 of the traffic on Path B.

### 3.2. Equal Cost Traffic Distribution

Under some approaches, load balancing algorithms such as ECMP algorithms may operate to evenly distribute traffic across all (network or packet forwarding) path members in a multi-path group. Unique or pre-replicated path members may be replicated in proportion to their respective data packet forwarding capacities—e.g., as a ratio of the data packet forwarding capacity over a common denominator or unit capacity such as 100 G, etc.—into multiple instances of path members in the equal cost load balancing algorithms. All replicated path members are deemed to have or to be assigned with the same weight in the equal cost load balancing (or traffic distribution) algorithms.

These equal cost load balancing algorithms are implemented to evenly distribute traffic among all path members of the same capacity in an ECMP group. Hence, for a WCMP group with different capacities among its path members, a capacity unit such as a (e.g., largest or otherwise, etc.) common denominator among all the different capacities may be determined and used as multipliers to replicate unique or pre-replicated path members of the WCMP group.

For example, for a given path member of a specific capacity, a multiplier may be determined as a ratio of the specific capacity over a common denominator or unit capacity and used to replicate the given path member into multiple instances of the same path member in the equal cost load balancing algorithms. As a result, the larger the specific capacity of the path member, the more times the unique or pre-replicated path member is replicated into multiple instances in the equal cost load balancing algorithms, and hence the more likely the unique or pre-replicated path member is selected by the equal cost load balancing algorithms by way of its multiple instances to carry traffic flows.

A disadvantage of these algorithms/implementations of load balancing among path members of WCMPs is that the path member list for each WCMP group becomes relatively large due to replication of previously unique path members. Hence, these replicated path members used to distribute traffic in proportion to capacities may take up or consume relatively large memory usage in operation.

The memory usage issue becomes even more exacerbated when sporadic link failures or maintenance operations impact even a relatively small number of data links that are part of paths in numerous multi-path groups in a relatively large network. For example, in operation, a single link failure in a communication network portion such as illustrated in FIG. 1D causes an increase of its (replicated) path members group size, for example from 2 to 7—more than three times of the pre-replicated path members in the group.

Indeed, while the total number of unique (or pre-replicated) path members in the group may be relatively small (e.g., <16, etc.), but due to differences in the weights or capacities among different path members in these unique path members, the total number of the replicated path members in a single group may be relatively large such as 256 or more.

A deployment of a communication or computer network may have thousands of active WCMP groups in operation at any given time for just a single node in the network. The amount of memory usage/consumption to store all replicated path members across each of all these WCMP groups becomes significantly or relatively large. The increase of memory usage/consumption may be proportional to or multiple of the sum of weights or capacities across all path members—for example, as divided by a capacity unit such as 100G or 100M, etc.

The unique or pre-replicated path members of the multi-path group may become more imbalanced in operation because of various sporadic link failures impacted by faults or maintenance in the network or nodes thereof and/or because of the introduction or new provisioning of new network elements for example with faster links. As the differences among (e.g., actual, effective, etc.) weights and capacities for forwarding packets become more significant or varied, the common denominator or unit capacity—e.g., a common denominator capacity amount among these different weights or capacities-used to determine multipliers for replications may become smaller than before, thereby incurring more memory usage or consumption and correspondingly more power consumption and latency in the network or network nodes/devices thereof.

With the relatively large memory usage/consumption incurred by these load balancing algorithms for WCMP, even if these algorithms were implemented in hardware (e.g., IC, ASIC, etc.), large footprints, sizes or areas would result in the hardware as well as large power consumption/usage would be incurred by the hardware implementing these algorithms.

### 3.3. Replication-Free Path Selection

In contrast, techniques as described herein may be used to implement load balancing algorithms for weighted ECMP groups or WCMP groups relatively efficiently in hardware, resulting in minimized footprint/size/area in the hardware as well as power savings in operation. These algorithms can robustly, efficiently and reliably distribute traffic among path members of a multi-path group in accordance with their actual capacities for forwarding packets, regardless of any differences in weights or (packet forwarding) capacities of these path members or runtime link failures that may affect the (e.g., actual, etc.) weights or capacities of these path members in operation.

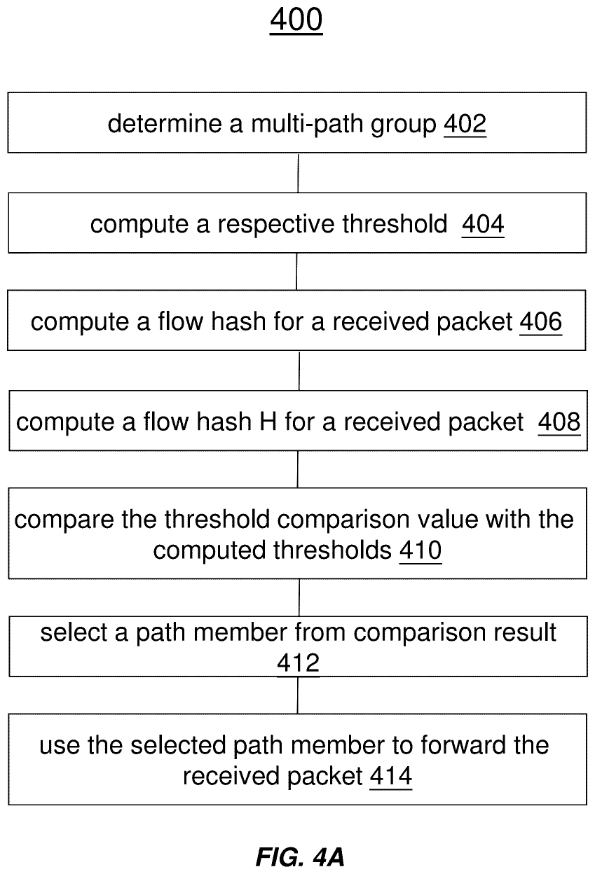

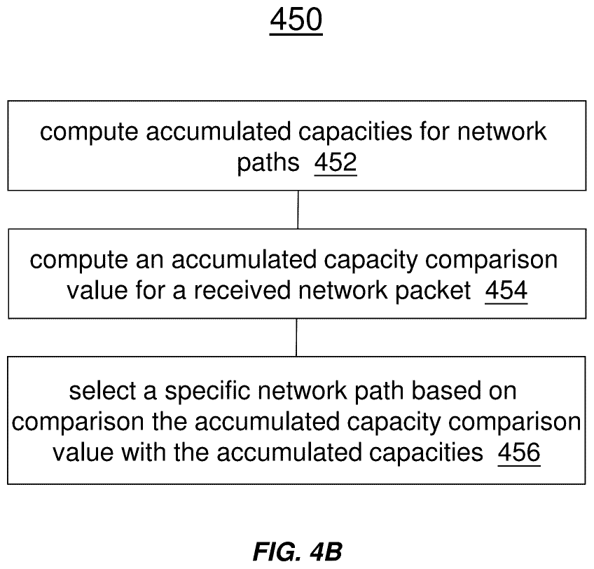

FIG. 4A illustrates an example process flow, according to an embodiment. The various elements of the flow described below may be performed by a networking device/such as a router implemented with one or more computing devices node deployed in a communication or computer network.

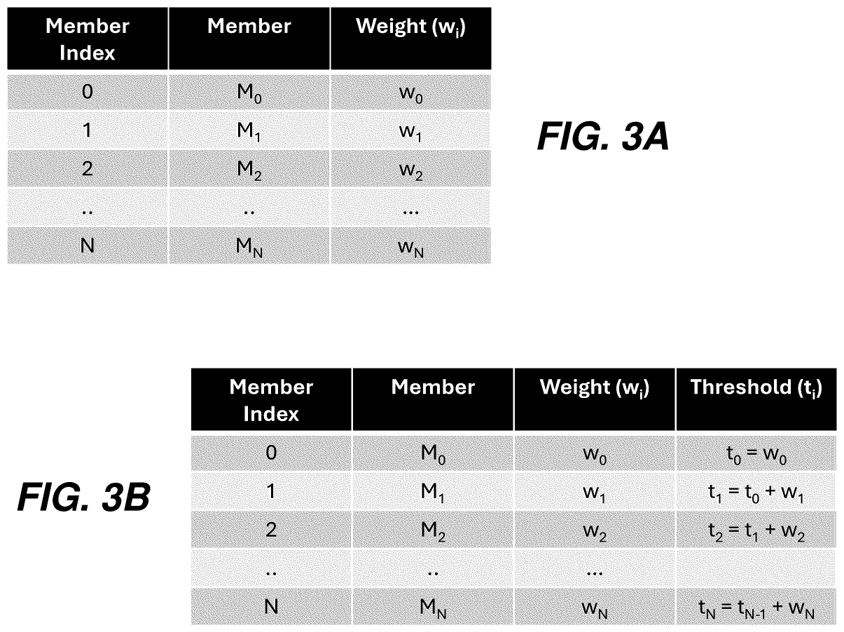

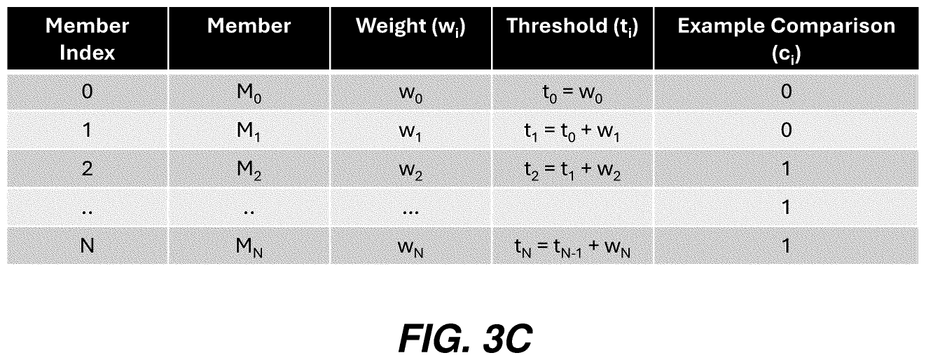

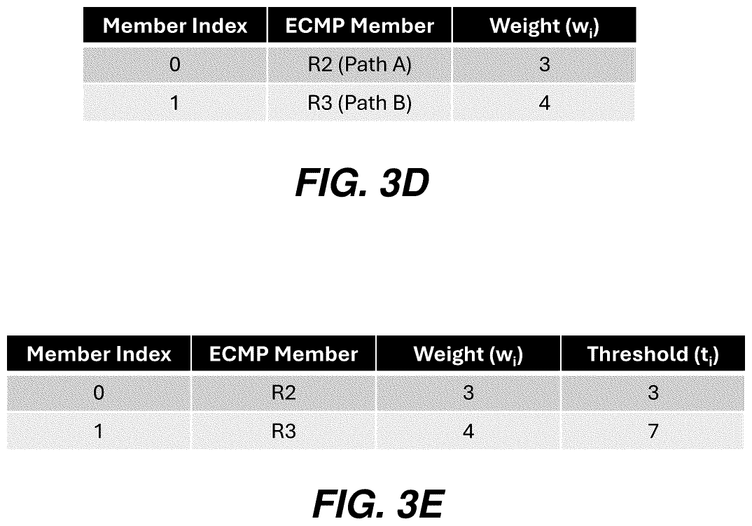

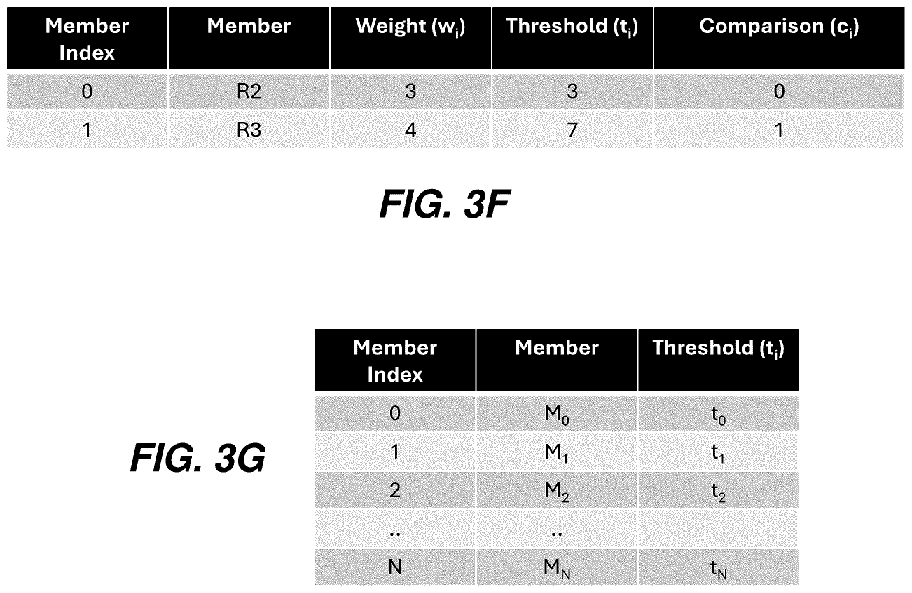

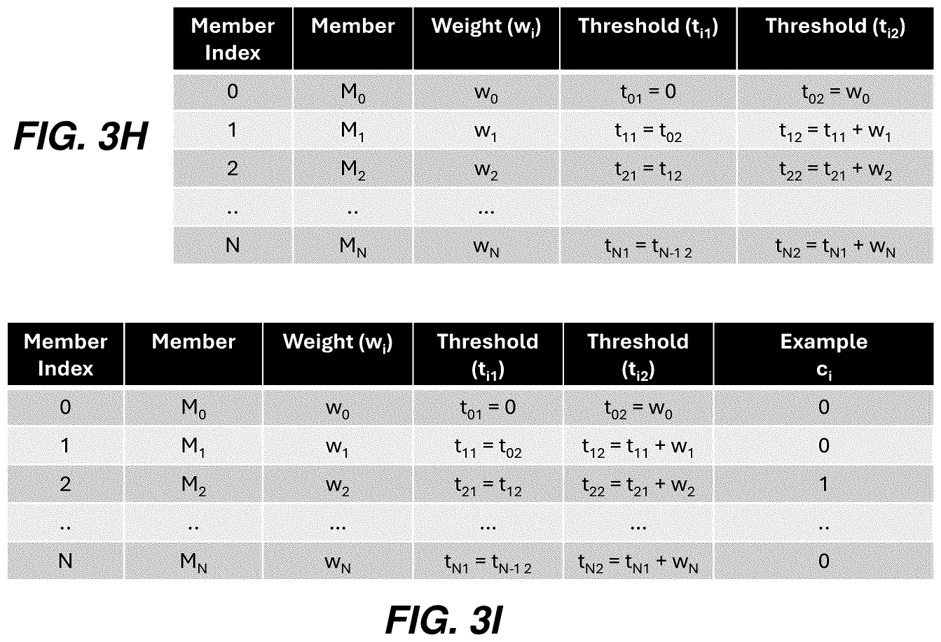

Block 402 comprises determining a multi-path group such as a WCMP group. For the purpose of illustration but not limitation, the multi-path group may include N+1 path members M₀ through M_{N}, where N represents a positive integer greater than zero (0). As illustrated in FIG. 3A, these path members in the group may be ordered. For example, each path member in the group may be ordered indexed with a respective index value i, where i represents an integer between 0 and N. A respective (packet forwarding) capacity for the i-th path member Mᵢ in the multi-path group may be represented by the i-th weight wᵢ in a plurality of weights w₀ through w_{N}.

Block 404 comprises, for each path member (e.g., the i-th path member mᵢ, etc.), computing a respective threshold (value) tᵢ in a plurality of thresholds (or threshold values) to through t_{N}, by adding or summing up the weights of all previous path members before the path member (the i-th path member mᵢ in the present example) with the weight of the i-th path member, as illustrated in the rightmost column of a table in FIG. 3B.

Block 406 comprises, in response to receive a data unit such as a network packet in a flow of network packets to be forwarded by the network node using the multi-path group, computing a (e.g., 16-bit, 32-bit, etc.) flow-specific value, such as (in some operational scenarios) a flow hash H for the packet. This flow hash H may be the same for all network packets in the flow including the (current) network packet in the flow to be forwarded by the network node. For example, the flow hash H may be computed based on packet data fields of the network packet or metadata extracted, maintained, buffered or generated for the network packet by or in the network node. These packet data fields or metadata may be used to distinguish network packets in the flow from other flows of network packets and may be the same for all network packets in the same flow. The flow hash H may be computed with a hash function such as CRC16, CRC32, or another hash function, etc.

Block 408 comprises using all the bits of the flow-specific value such as the flow hash H or a subset of specific bits extracted therefrom (e.g., most significant bits, least significant bits, or a chunk of bits among all the bits of H, etc.) to derive a pre-modulo value H′, which in turn is used to compute a threshold comparison value k as H′ modulo ty (the last threshold of all the ordered/indexed path members of the multi-path group), as follows:

k=H′ modulo t_{N} (where H′ is derived from H) (4)

where the last threshold t_{N} represents the total packet forwarding capacity of the multi-path group.

Block 410 comprises comparing the threshold comparison value k with each of the computed thresholds (or threshold values) for all the path members of the multi-path group. An example of the threshold comparison may be performed as follows:
for each path member i:

| | |
|---|---|
| if (k < tᵢ) | |
| cᵢ = 1 | (5) |
| else | |
| cᵢ = 0 | |

where cᵢ represents a binary result of threshold comparison for the i-th path member in the multi-path group.

The comparison operations in (5) above generate a comparison vector that is composed of binary results (or component binary values) c₀ through c_{N} as illustrated in the rightmost column of a table in FIG. 3C. For the purpose of illustration only, these binary results indicate a binary value of zero (0 or false) for the first two path members of the multi-path group and a binary value of one (1 or true) for all the subsequent path members of the multi-path group, as ordered or indexed by their respective index values.

Block 412 comprises starting from the 0-th path member, traverse the comparison results c₀ through c_{N} to find the first path member with an index value of j with cⱼ=1. For the purpose of illustration only, j=2, as illustrated in FIG. 3C.

Block 414 comprises selecting, by the network node, this first path member mⱼ with cⱼ=1 to be the member or path in the multi-path group for forwarding the network packet.

### 3.4. Path Selection Examples

By way of example but not limitation, the load balancing algorithm or process flow of FIG. 4A may be applied by a network node R1 to distribution traffic for a multi-path group or an ECMP group that includes or is composed of two path members after the multi-path group of FIG. 1D has experienced a link failure of one of four 100G network link from R2 to R4.

As illustrated in FIG. 3D, the two path members may be denoted as Path A via R2 and Path B via R1, respectively. The corresponding index values for Path A and Path B may be 0 and 1, respectively. Path A and Path B may be configured, provisioned or assigned with (e.g., actual, present, updated, etc.) packet forwarding capacities, respectively represented by two proportional weights of three (3) and four (4), respectively.

In block 404, the network node R1 may compute thresholds or threshold values for the two path members in the multi-path group. In the present example, the thresholds for Path A (or R2) and Path B (or R3) may be 3 and 7, respectively, as illustrated in the rightmost column of a table in FIG. 3E.

In blocks 406 and 408, in response to receiving a network packet in a flow of network packets by the network node R1, a flow-specific value such as a flow hash H is computed on the network packet's data fields used to distinguish the flow from other flows that may be handled by the network node R. A derived pre-modulo value H′ may be computed or derived from some or all bits of the flow hash H. A threshold comparison value k may be computed, as follows:

k=H′ modulo 7 (6)

For the purpose of illustration only, k=5.

In block 410, the network node R1 performs comparison operations between the threshold comparison value k and each of the thresholds of the path members of the multi-path group to generate a comparison vector that is composed of two binary results (or component binary values) c₀ and c₁ as illustrated in the rightmost column of a table in FIG. 3F.

In block 412, the network node R1 may operate to identify he first path member, among all the ordered or indexed path members in the multi-path group, with a binary comparison value ci=1. In the present example, R3 or Path B is that first path member with the binary comparison value c₁=1.

Accordingly, in block 414, the network node R1 selects R3 or Path B for forwarding the received network packet.

As the threshold comparison value k is derived from a flow-specific value that is relatively evenly distributed among all the flows as a modulo of the total (available) cumulative data carrying capacity of path members in the multi-path group, k is also expected to be relatively evenly distributed in the available data carrying capacity of the index values of the path members across the multiple flows in the network or handled by the network node R1. In the present example, flows with k=0, 1, or 2 cause a selection of R2 or Path A for forwarding packets, whereas flows with k=3, 4, 5, 6 cause a selection of R3 or Path B for forwarding packets. As a result, the desired distribution of the traffic from the origination endpoint X to the destination endpoint Y can be achieved under this load balancing algorithm or process flow.

This algorithm can be implemented or performed with minimized memory usage or consumption. For example, in some operational scenarios, as illustrated in FIG. 3G, a single array of pre-computed thresholds (before handling or distributing upcoming network packets) may be stored in memory or hardware (e.g., an array of registers, an array of memory entries of a relatively small fixed or constant size, etc.). In contrast with other approaches, the minimized memory usage or consumption under techniques as described herein does not depend on differences in capacities or weights of path members in a multi-path group. Hence, changes in capacities or weights caused by link failures in operations do not affect or increase this minimized memory usage. Furthermore, additions or removals of members from the multi-path group also affect little this minimized memory usage/consumption. As a result, the algorithm or process flow can be implemented in hardware with relatively high efficiency and relatively small footprint/size/area.

### 3.5. Implementation Variations

In various operational scenarios, load balancing (or traffic distribution) algorithms, methods or process flows as described herein may be implemented in any of multiple variants.

For example, as noted, block 410 of FIG. 4A comprises comparing the threshold comparison value k with each of the computed thresholds (or threshold values) for all the path members of the multi-path group. Block 412 comprises starting from the 0-th path member, traverse the comparison results c₀ through c_{N} to find the first path member with an index value of j with cⱼ=1.

In a first example variant, instead of performing the threshold comparison in expression (5) above, in block 410, an alternative threshold comparison may be performed as follows:

for each member i:

| | |
|---|---|
| if (k < tᵢ) | |
| cᵢ = 0 | (5′) |
| else | |
| cᵢ = 1 | |

Moreover, instead of finding the first path member with an index value of j with cⱼ=1, block 412 in this first example variant comprises starting from the 0-th path member, traverse the comparison results c₀ through c_{N} to find the first path member with an index value of j with cⱼ=0. This first path member with cⱼ=0 may be selected from among the multiple path members of the multi-path group for forwarding the received network packet.

As noted, block 404 of FIG. 4A comprises, for each path member (e.g., the i-th path member mᵢ, etc.), computing a respective threshold (value) tᵢ in a plurality of thresholds to through t_{N}, by adding or summing up the weights of all previous path members before the path member in the plurality of ordered/indexed path members of the multi-path group.

In a second example variant, the i-th threshold may be computed as follows:

$${t}_{i} = ( {t}_{0} + {t}_{1} + {t}_{2} + … + {t}_{i} ) - 1 \qquad ( 7 )$$

Correspondingly, in the second example variant, in block 410, an alternative threshold comparison may be performed as follows:
for each member i:

| | |
|---|---|
| if (k ≤ ti) | |
| ci = 1 | (5″) |
| else | |
| ci = 0 | |

The largest threshold in this second example variant could be one (1) bit smaller than the previously illustrated load balancing algorithm, method or process flow of FIG. 4A.

Instead of computing only a single threshold (or a single threshold value) such as tᵢ for each (e.g., the i-th, etc.) path member in the plurality of ordered/indexed path members in a multi-path group, in a third example variant, block 404 comprises, for each path member (e.g., the i-th path member mᵢ, etc.), computing two respective thresholds (or two threshold values) tᵢ₁ and tᵢ₂ in a plurality of pairs of thresholds (or pairs of threshold values) (t₀₁, t₀₂) through (t_{N2}, t_{N2}), as follows:
for each member i:

$${t}_{i 1} = {w}_{0} + {w}_{1} + … + {w}_{i - 1} \qquad ( 8 )$$

$${t}_{i 2} = {t}_{i 1} + {w}_{i}$$

Hence, for each path member (or the i-th path member) in the plurality of ordered/indexed path members in the multi-path group, the first threshold tᵢ in a pair of thresholds for the (i-th) path member is the sum of the weights of all previous path members before the (i-th) path member, whereas the second threshold tᵢ₂ in the pair of thresholds for the (i-th) path member is the sum of the weights of all previous path members before the (i-th) path member and the weight of the i-th path member, as illustrated in FIG. 3H.

Correspondingly, in the third example variant, in block 410, an alternative threshold comparison may be performed as follows:
for each member i:

| | |
|---|---|
| if ((k ≥ ti1) && (k < ti2)) | |
| ci = 1 | (9) |
| else | |
| ci = 0 | |

An example of binary comparison results computed with the alternative threshold comparison is illustrated in FIG. 3I. Blocks 406, 408, 412 and 414 of FIG. 4A remain the same in this third example variant. As compared with other variants, this variant stores slightly more data per-path member, block 412 of FIG. 4A may be implemented with a relatively easy-to-implement simple decoder, for example in hardware with relatively high efficiency and performance.

### 4.0. EXAMPLE EMBODIMENTS

FIG. 4B illustrates an example process flow, according to an embodiment. The various elements of the flow described below may be performed by one or more network devices implemented with one or more computing devices. In block 452, a network device as described herein or a path selector therein computes respective cumulative data carrying capacities for selected network paths in a group of network paths defining a multi-path group used to forward network packets from a first network node to a second network node.

In block 454, the network device computes a cumulative capacity comparison value for a received network packet in a flow of network packets based at least in part on a hash value used to distinguish the flow from other flows of network packets.

In block 456, the network device selects a specific network path from amongst the network paths of the multi-path group, over which to forward the received network packet from the first network node towards the second network node, based on comparing the cumulative capacity comparison value with at least a subset of the cumulative data carrying capacities.

In an embodiment, each cumulative capacity in the respective cumulative data carrying capacities is computed for a respective network path in the network paths based at least in part on a sum of weights assigned to a respective weight assigned to the respective network path and all previous network paths before the respective network path among the network paths in a specific order.

In an embodiment, the cumulative capacity comparison value is computed as a flow-specific value modulo total weights of the network paths in the multi-path group.

In an embodiment, the multi-path group represents one of: a weighted cost multi-path (WCMP) group, an equal cost multi-path (ECMP) group, or the like.

In an embodiment, the hash value is computed based on one or more of packet data fields or packet metadata determined for the received network packet.

In an embodiment, the network device further performs: storing the respective cumulative data carrying capacities in memory for selecting network paths for forwarding network packets from the first network node to the second network node until there is a change in any weight assigned to any of the network paths.

In an embodiment, the comparison of the cumulative capacity comparison value with at least the subset of the cumulative data carrying capacities is performed with hardware logic in parallel.

In an embodiment, a computing device such as a switch, a router, a line card in a chassis, a network device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### 5.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques. Such special-purpose computing devices may also combine custom hard-wired logic, ASICs, FPGAs, or other circuitry with custom programming to accomplish the techniques.

Though certain foregoing techniques are described with respect to a hardware implementation, which provides a number of advantages in certain embodiments, it will also be noted that, in other embodiments, the foregoing techniques may still provide certain advantages when performed partially or wholly in software. Accordingly, in such an embodiment, a suitable implementing apparatus comprises a general-purpose hardware processor and is configured to perform any of the foregoing methods by executing program instructions in firmware, memory, other storage, or a combination thereof.

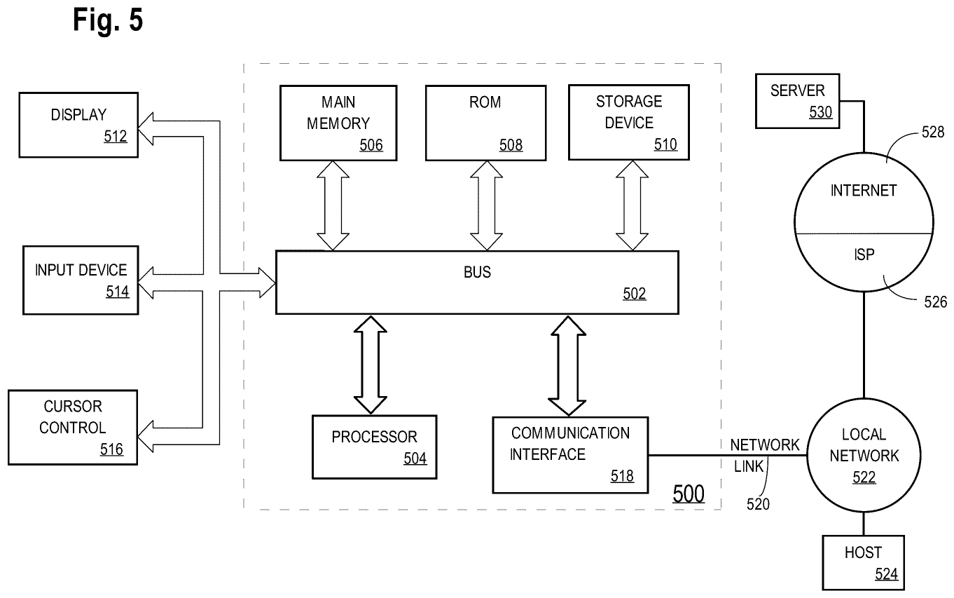

FIG. 5 is a block diagram that illustrates an example computer system 1300 that may be utilized in implementing the above-described techniques, according to an embodiment. Computer system 1300 may be, for example, a desktop computing device, laptop computing device, tablet, smartphone, server appliance, computing mainframe, multimedia device, handheld device, networking apparatus, or any other suitable device. In an embodiment, FIG. 5 constitutes a different view of the devices and systems described in previous sections.

Computer system 500 may include one or more ASICs, FPGAs, or other specialized circuitry 503 for implementing program logic as described herein. For example, circuitry 503 may include fixed and/or configurable hardware logic blocks for implementing some or all of the described techniques, input/output (I/O) blocks, hardware registers or other embedded memory resources such as random-access memory (RAM) for storing various data, and so forth. The logic blocks may include, for example, arrangements of logic gates, flip-flops, multiplexers, and so forth, configured to generate an output signals based on logic operations performed on input signals.

Additionally, and/or instead, computer system 500 may include one or more hardware processors 504 configured to execute software-based instructions. Computer system 500 may also include one or more busses 502 or other communication mechanism for communicating information. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes one or more memories 506, such as a RAM, hardware registers, or other dynamic or volatile storage device for storing data units to be processed by the one or more ASICs, FPGAs, or other specialized circuitry 503. Memory 506 may also or instead be used for storing information and instructions to be executed by processor 504. Memory 506 may be directly connected or embedded within circuitry 503 or a processor 504. Or, memory 506 may be coupled to and accessed via bus 502. Memory 506 also may be used for storing temporary variables, data units describing rules or policies, or other intermediate information during execution of program logic or instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, may optionally be provided and coupled to bus 502 for storing information and instructions.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as an 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send and receive data units through the network(s), network link 520, and communication interface 518. In some embodiments, this data may be data units that the computer system 500 has been asked to process and, if necessary, redirect to other computer systems via a suitable network link 520. In other embodiments, this data may be instructions for implementing various processes related to the described techniques. For instance, in the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

Computer system 500 may optionally be coupled via bus 502 to one or more displays 512 for presenting information to a computer user. For instance, computer system 500 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

One or more input devices 514 are optionally coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

As discussed, computer system 500 may implement techniques described herein using customized hard-wired logic, one or more ASICs or FPGAs 503, firmware and/or program logic, which in combination with the computer system causes or programs computer system 500 to be a special-purpose machine. According to one embodiment, however, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 506, from which processor 504 retrieves and executes the instructions. The instructions received by main memory 506 may optionally be stored on storage device 510 either before or after execution by processor 504.

### 6.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the inventive subject matter have been described with reference to numerous specific details that may vary from implementation to implementation. Thus, the sole and exclusive indicator of what is the inventive subject matter, and is intended by the applicants to be the inventive subject matter, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for selecting a transmission path in a multi-path network link, the method comprising:
computing respective cumulative data carrying capacities for selected network paths in a group of network paths defining a multi-path group used to forward network packets from a first network node to a second network node;
computing a cumulative capacity comparison value for a received network packet in a flow of network packets based at least in part on a hash value used to distinguish the flow from other flows of network packets;
selecting a specific network path from amongst the network paths of the multi-path group, over which to forward the received network packet from the first network node towards the second network node, based on comparing the cumulative capacity comparison value with at least a subset of the cumulative data carrying capacities.

2. The method of claim 1, wherein each cumulative capacity in the respective cumulative data carrying capacities is computed for a respective network path in the network paths based at least in part on a sum of a respective weigh assigned to the respective network path and respective weights of all previous network paths before the respective network path among the network paths in a specific order.

3. The method of claim 1, wherein the cumulative capacity comparison value is computed as a flow-specific value modulo total weights of the network paths in the multi-path group.

4. The method of claim 1, wherein the multi-path group represents one of: a weighted cost multi-path (WCMP) group or an equal cost multi-path (ECMP) group.

5. The method of claim 1, wherein the hash value is computed based on one or more of packet data fields or packet metadata determined for the received network packet.

6. The method of claim 1, further comprising: storing the respective cumulative data carrying capacities in memory for selecting network paths for forwarding network packets from the first network node to the second network node until there is a change in any weight assigned to any of the network paths.

7. The method of claim 1, wherein said comparing the cumulative capacity comparison value with at least the subset of the cumulative data carrying capacities is performed with hardware logic in parallel.

8. A system comprising:
one or more computing devices;
one or more non-transitory computer readable media storing instructions that, when executed by the one or more computing devices, cause performance of:
computing respective cumulative data carrying capacities for selected network paths in a group of network paths defining a multi-path group used to forward network packets from a first network node to a second network node;
computing a cumulative capacity comparison value for a received network packet in a flow of network packets based at least in part on a hash value used to distinguish the flow from other flows of network packets;
selecting a specific network path from amongst the network paths of the multi-path group, over which to forward the received network packet from the first network node towards the second network node, based on comparing the cumulative capacity comparison value with at least a subset of the cumulative data carrying capacities.

9. The system of claim 8, wherein each cumulative capacity in the respective cumulative data carrying capacities is computed for a respective network path in the network paths based at least in part on a sum of weights assigned to a respective weight assigned to the respective network path and all previous network paths before the respective network path among the network paths in a specific order.

10. The system of claim 8, wherein the cumulative capacity comparison value is computed as a flow-specific value modulo total weights of the network paths in the multi-path group.

11. The system of claim 8, wherein the multi-path group represents one of: a weighted cost multi-path (WCMP) group or an equal cost multi-path (ECMP) group.

12. The system of claim 8, wherein the hash value is computed based on one or more of packet data fields or packet metadata determined for the received network packet.

13. The system of claim 8, further comprising: storing the respective cumulative data carrying capacities in memory for selecting network paths for forwarding network packets from the first network node to the second network node until there is a change in any weight assigned to any of the network paths.

14. The system of claim 8, wherein said comparing the cumulative capacity comparison value with at least the subset of the cumulative data carrying capacities is performed with hardware logic in parallel.

15. One or more non-transitory computer readable media storing instructions that, when executed by one or more computing devices, cause performance of:
computing respective cumulative data carrying capacities for selected network paths in a group of network paths defining a multi-path group used to forward network packets from a first network node to a second network node;
computing a cumulative capacity comparison value for a received network packet in a flow of network packets based at least in part on a hash value used to distinguish the flow from other flows of network packets;
selecting a specific network path from amongst the network paths of the multi-path group, over which to forward the received network packet from the first network node towards the second network node, based on comparing the cumulative capacity comparison value with at least a subset of the cumulative data carrying capacities.

16. The media of claim 15, wherein each cumulative capacity in the respective cumulative data carrying capacities is computed for a respective network path in the network paths based at least in part on a sum of weights assigned to a respective weight assigned to the respective network path and all previous network paths before the respective network path among the network paths in a specific order.

17. The media of claim 15, wherein the cumulative capacity comparison value is computed as a flow-specific value modulo total weights of the network paths in the multi-path group.

18. The media of claim 15, wherein the multi-path group represents one of: a weighted cost multi-path (WCMP) group or an equal cost multi-path (ECMP) group.

19. The media of claim 15, wherein the hash value is computed based on one or more of packet data fields or packet metadata determined for the received network packet.

20. The media of claim 15, further comprising: storing the respective cumulative data carrying capacities in memory for selecting network paths for forwarding network packets from the first network node to the second network node until there is a change in any weight assigned to any of the network paths.

21. The media of claim 15, wherein said comparing the cumulative capacity comparison value with at least the subset of the cumulative data carrying capacities is performed with hardware logic in parallel.
